(19) United States
(12) Patent Application Publication
(10) Pub. No.: US 2012/0195773 A1
(43) Pub. Date: Aug. 2, 2012

(54) SLEEVE BEARING

(75) Inventors: Brian DASCHNER, Fairview, TN (US); Doug Daschner, Fairview, TN (US)

(73) Assignee: Hydroflo Pumps USA, Inc.,, Fairview, TN (US)

(21) Appl. No.: 13/018,691

(22) Filed: Feb. 1, 2011

(51) Int. Cl. F04B 39/00; B21D 53/10; F16C 35/02

(52) U.S. Cl. 417/374; 384/295; 29/898.054; 29/898.055

(57) ABSTRACT

A sleeve bearing is provided. The sleeve bearing comprises a bearing retainer including an outer surface and an inner surface, wherein the inner surface forms a retaining bore, a bearing insert including an outside surface and an inside surface, wherein the inside surface forms a shaft bore, and wherein the bearing insert is coupled to the bearing retainer.

### TECHNICAL FIELD

This invention relates to bearings and, more particularly, to water or oil lubricated sleeve bearings for use in carrying a rotating shaft in various industrial applications such as vertical pumps

### BACKGROUND OF THE INVENTION

A vertical turbine pump typically comprises a head portion, a motor assembly supported by the head portion, a column pipe, a line shaft assembly and an impeller assembly. The head portion supports the motor assembly and comprises a mounting section and a discharge outlet for the pump.

The column pipe is attached at the base of the head portion and includes an impeller-bowl section and a suction inlet of the pump. The line shaft assembly corresponds to a collection of shaft-like components, which transfer power from the motor assembly to the impeller assembly to produce the required hydraulic conditions. In a typical vertical turbine pump, line shaft assembly components will include a motor-interfacing section which is operatively coupled to the motor assembly, a bottom or impeller-rotating section on which the impeller assembly is mounted and an intermediate section coupled to the motor-interfacing section and the impeller-rotating section. The impeller assembly usually comprises a set of impeller blades.

When the motor assembly rotates, the line shaft assembly, and thus the impeller assembly, causes the working fluid to be drawn through the suction inlet of the pump and discharged at a higher pressure at the pump discharge outlet. More particularly, fluid is drawn into a central region of each impeller blade and is discharged at a higher pressure and a higher temperature at the blade's periphery.

In order to keep the line shaft assembly aligned and give rotational support during operation, bearings are inserted between the column pipe and the line shaft assembly. Bearings are commonly comprised of bronze or dual bronze and rubber. A problem associated with vertical pumps and their rotating parts is the overheating of the bearings in which the parts rotate. Bearing overheating may be the result of the breaking down of the chemical integrity of a lubricant with a consequent loss of lubricating qualities or the interruption of the flow of lubricant through passages in the bearings.

The loss of lubricant integrity or flow causes increased friction which, in turn, allows the pump shaft and bearings to overheat. If left unchecked, a typical bronze bearing will experience massive wear very quickly, resulting in pump shaft failure. Therefore there is a need for an improved bearing which functions in a non-lubricated “dry” state for a longer period in order to mitigate damage to a vertical turbine pump The embodiments described below provide these and other advantages and an advance in the art is achieved.

### SUMMARY OF THE INVENTION

A sleeve bearing is provided according to embodiments described below. According to an embodiment, the sleeve bearing comprises a bearing retainer including an outer surface and an inner surface, wherein the inner surface forms a retaining bore, a bearing insert including an outside surface and an inside surface, wherein the inside surface forms a shaft bore, and wherein the bearing insert is coupled to the bearing retainer.

A pump for a fluid delivery system is provided according to embodiments described below. According to an embodiment, the pump comprises a head portion comprising a discharge outlet, a motor coupled to the head portion for actuating portions of the pump, a column pipe extending from the head portion, a line shaft internal to the column pipe and coupled to the motor for actuation during pump operation, a sleeve bearing positioned between the column pipe and line shaft for aligning and rotatively supporting the line shaft, wherein the sleeve bearing further comprises a bearing retainer including an outer surface and an inner surface wherein said inner surface forms a retaining bore, a bearing insert including an outside surface and an inside surface wherein the inside surface forms a shaft bore, and wherein the bearing insert is coupled to the bearing retainer, and one or more impellers coupled to the line shaft.

A method of forming a sleeve bearing is provided according to embodiments described below. According to an embodiment, the method comprises a step of forming a bearing retainer including an outer surface and an inner surface wherein the inner surface forms a retaining bore, forming a bearing insert including an outside surface and an inside surface wherein the inside surface forms a shaft bore, and coupling the bearing insert to the bearing retainer.

### BRIEF DESCRIPTION OF THE DRAWINGS

FIG. 1 is a partial section view of a water lubricated vertical turbine pump according to an embodiment of the present invention;

FIG. 2 is a partial section view of an oil lubricated/waterflush vertical turbine pump according to an embodiment of the present invention; and

FIG. 3 is an exploded isometric view of one form of the sleeve bearing of the present invention.

### DETAILED DESCRIPTION OF THE INVENTION

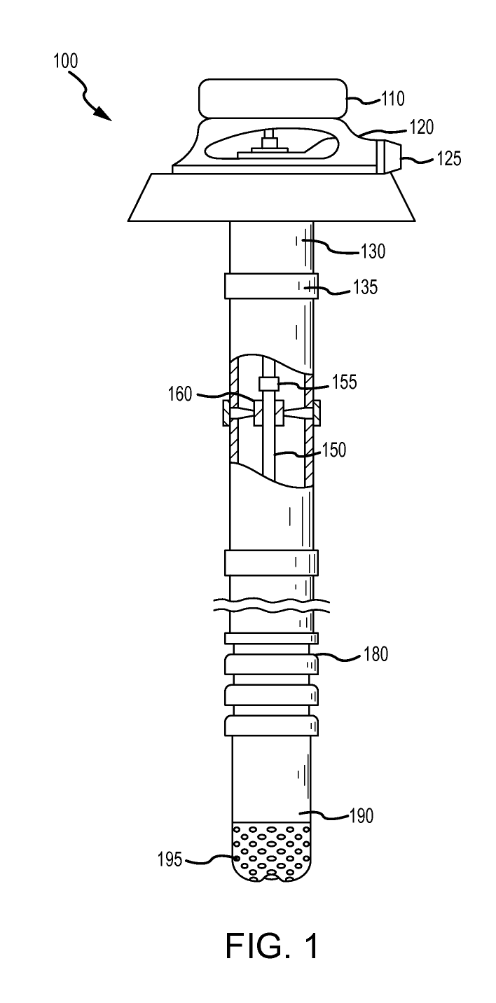

FIGS. 1-3 and the following description depict specific examples to teach those skilled in the art how to make and use the best mode of embodiments of a sleeve bearing. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the sleeve bearing. As a result, the embodiments described below are not limited to the specific examples described below, but only by the claims and their equivalents.

FIG. 1 shows a typical water-lubricated pump. This pump, as generally referred to by numeral 100, is formed by a motor 110 located on a head portion 120 wherein there is also a discharge outlet 125. From head portion 120, a column pipe 130 extends downwardly and is formed by pipe lengths connected together via coupling 135. Spaced throughout and coupled to column pipe 130 are sleeve bearings 160, which serve for aligning and rotatively supporting a line shaft 150. Said line shaft 150 is formed by shaft portions, connected to one another by means of couplings 155, in order to obtain the required depth. Line shaft 150 is coupled to motor 110 for actuation during pump operation.

Column pipe 130 and line shaft 150 continue as deep as necessary, and end with a plurality of impeller bowls 180, serially arranged near the lower end of pump 100. Beyond bowls 180, pump 100 terminates at a suction end 190, provided with a strainer 195.

In operation, the fluid to be extracted from a source, e.g. water, enters through the strainer 195 towards the suction end 190, due to the action of said impeller bowls. The impeller bowls are moved, in turn, by the line shaft rotation carrying said bowls and communicating thereto the motor power and in such a way, that water enters the column pipe, goes upwardly through the discharge outlet 125 and, at the same time, said water lubricates the line shaft 150 with said bearings 160 inside column pipe 130.

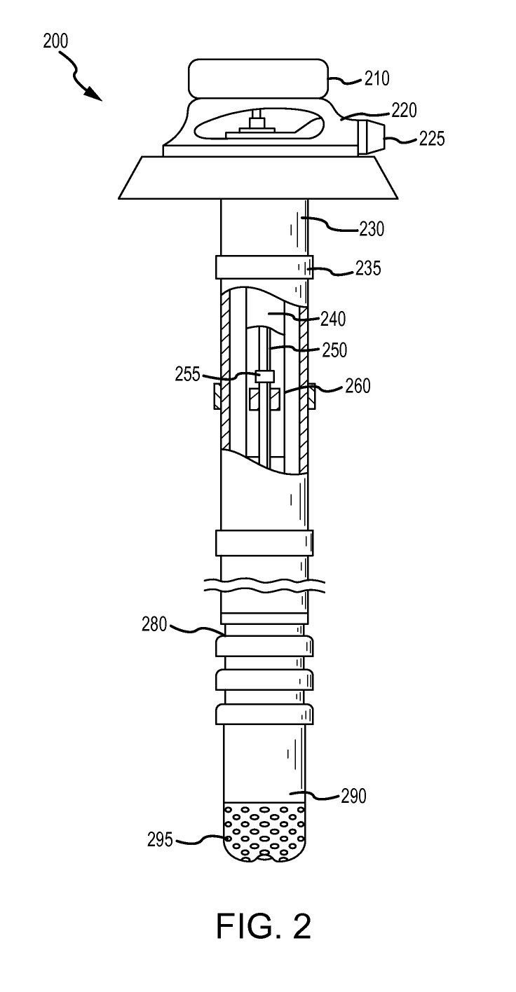

FIG. 2 shows a typical oil-lubricated/waterflush pump Pump 200 is formed by a motor 210 located on a head portion 220 wherein there is also a discharge outlet 225. From head portion 220, a column pipe 230 extends downwardly and is formed by pipe lengths connected together via coupling 235.

Located within column pipe 230 is a shaft sheath 240, formed by tubular elements connected to one another using couplings similar to column pipe 230. Spaced throughout and coupled to shaft sheath 240 are sleeve bearings 260, which serve for aligning and rotatively supporting a line shaft 250. Said line shaft 250 is formed by shaft portions, connected to one another by means of couplings 255, in order to obtain the required depth. Line shaft 250 is coupled to motor 210 for actuation during pump operation.

Column pipe 230 and line shaft 250 continue as deep as necessary, and end with a plurality of impeller bowls 280, serially arranged near the lower end of pump 200. Shaft sheath 240 ends at a set length above impeller bowls 280 and is capped at a bottom end portion, thus surrounding the line shaft 250 to form a chamber in which lubricating fluid (i.e. oil or water) resides. Beyond bowls 280, pump 200 terminates at a suction end 290, provided with a strainer 295.

In operation, the fluid to be extracted from a source, e.g. water, enters through the strainer 295 towards the suction end 290, due to the action of said impeller bowls 280. The impeller bowls 280 are moved, in turn, by the line shaft rotation carrying said bowls and communicating thereto the motor power and in such a way, that water enters pump 200 between column pipe 230 and shaft sheath 240, travels upwardly through the discharge outlet 225 without contacting said shaft 250 or the bearings 260 protected by said shaft sheath 240.

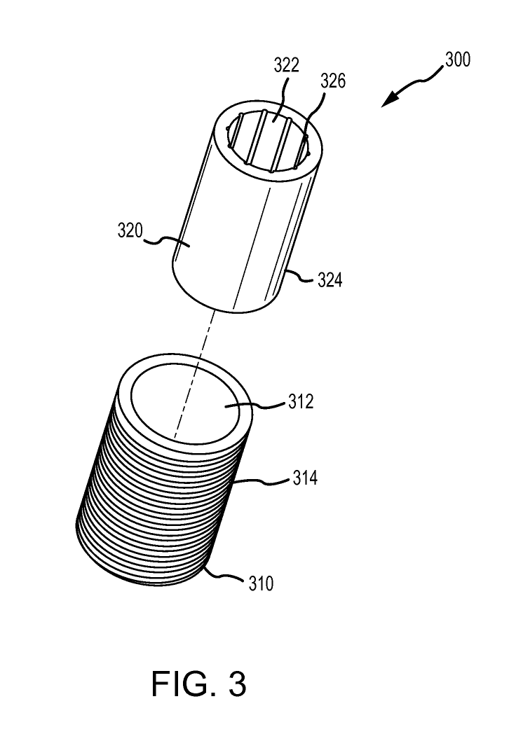

FIG. 3 is a sleeve bearing according to one aspect of the invention. Sleeve bearing 300 comprises a bearing retainer 310 and a bearing insert 320. Bearing retainer 310 is of a tubular form with an inner surface 312 and an outer surface 314. Bearing retainer 310 is formed from stainless steel due to its high tensile strength, enabling a thin walled tubular formation. Preferably, type 201SS, 304SS or 316SS is used; however, other types of stainless steel or material with a high tensile strength can be used. Outer surface 314 can comprise a location feature to allow for coupling and location of sleeve bearing 300 onto column pipe 130 or shaft sheath 240 depending on the type of pump. By way of example, outer surface 314 can be threaded or may comprises notches or protrusions (not shown) that mate with corresponding features on the column pipe 130 or shaft sheath 240. Lastly, inner surface 312 forms a retaining bore to allow for the coupling of bearing insert 320.

Bearing insert 320 is of a tubular form with an inside surface 322 and an outside surface 324. Inside surface 322 forms a shaft bore, which allows for the insertion of a line shaft. Bearing insert 320 is formed of a synthetic polymeric, thermoplastic resin material, such as that marketed under the trade mark VESCONITE, of Vesco Plastics Pty. Ltd. In one embodiment of bearing 300, inside surface 312 of bearing retainer 310 and the outside surface 324 of bearing insert 320 are formed to dimensions allowing for bearing insert 320 to be press fit into the interior of bearing retainer 310. In another embodiment of bearing 300, bearing insert 320 is coupled to bearing retainer 310 via a shrink fit.

In an additional embodiment of bearing 300, inside surface 322 of bearing insert 320 has spaced around its circumference various channels 326 to allow for the flow of lubricant and/or working fluid through the sleeve bearing 300. In a preferred embodiment, channels 326 are semicircular in shape; however, other shapes can be used including triangular or square.

Bearing insert 320 can be formed from various processes including casting, extrusion, milling or machining. In one embodiment of the bearing 300, bearing insert 320 is heat treated to minimize expansion during periods of actual use where increased temperatures are experienced. Heat treatment can be performed on portions of bearing insert 320 or the entire insert. In one embodiment, inside surface 322 is subjected to a temperature of 200° F. for about 1 minute using a localized heat source. Such localized heat source can be in the form of a laser, heat coil or other element which raises the temperature of inside surface 322. In another embodiment, the entire bearing insert 320 can be heat treated. It should be understood that various portions of insert can be subjected to heat treatment and said heat treatment is not limited to the inside surface or the entire insert.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the sleeve bearing. It will also be apparent to those of ordinary skill in the art that the above-described embodiments may be combined in whole or in part to create additional embodiments within the scope and teachings of the present description.

Thus, although specific embodiments of, and examples for, the sleeve bearings are described herein for illustrative purposes, various equivalent modifications are possible within the scope of the present description, as those skilled in the relevant art will recognize. The teachings provided herein can be applied to other bearings, and not just to the embodiments described above and shown in the accompanying figures. Accordingly, the scope of the sleeve bearing should be determined from the following claims.

We claim:

1. A sleeve bearing, the sleeve bearing comprising:
a bearing retainer including an outer surface and an inner surface, wherein the inner surface forms a retaining bore;
a bearing insert including an outside surface and an inside surface, wherein the inside surface forms a shaft bore; and
wherein the bearing insert is coupled to the bearing retainer.

2. The sleeve bearing of claim 1 wherein the bearing retainer is formed from stainless steel and the bearing insert is formed from a thermoplastic resin.

3. The sleeve bearing of claim 2 wherein the thermoplastic resin is Vesconite.

4. The sleeve bearing of claim 1 wherein the outer surface of the bearing retainer comprises a location feature.

5. The sleeve bearing of claim 4 wherein the location feature is a threaded outer surface.

6. The sleeve bearing of claim 1 wherein the bearing insert is coupled to the bearing retainer by way of a press fit.

7. The sleeve bearing of claim 1 wherein the bearing insert is coupled to the bearing retainer by way of a shrink fit.

8. The sleeve bearing of claim 1 further comprising channels on the inside surface of the bearing insert in order to allow for flow of fluid through the sleeve bearing.

9. The sleeve bearing of claim 8 wherein the channels are semicircular in shape.

10. The sleeve bearing of claim 1 wherein the bearing insert is heat treated.

11. The sleeve bearing of claim 1 wherein only a portion of the bearing insert is heat treated.

12. A pump for use in a fluid delivery system, said pump comprising:
a head portion comprising a discharge outlet;
a motor coupled to the head portion for actuating portions of the pump;
a column pipe extending from the head portion;
a line shaft internal to the column pipe and coupled to the motor for actuation during pump operation;
a sleeve bearing positioned between the column pipe and line shaft for aligning and rotatively supporting the line shaft, wherein the sleeve bearing further comprises:
a bearing retainer including an outer surface and an inner surface wherein said inner surface forms a retaining bore;
a bearing insert including an outside surface and an inside surface wherein the inside surface forms a shaft bore; and wherein the bearing insert is coupled to the bearing retainer; and
one or more impellers coupled to the line shaft.

13. The pump of claim 12 wherein the bearing retainer is formed from stainless steel and said bearing insert is formed from a thermoplastic resin.

14. The pump of claim 13 wherein the thermoplastic resin is Vesconite.

15. The pump of claim 12 wherein the outer surface of the bearing retainer comprises a location feature.

16. The pump of claim 15 wherein the location feature is a threaded outer surface.

17. The pump of claim 12 wherein the bearings insert is coupled to the bearing retainer by way of a press fit.

18. The pump of claim 12 wherein the bearings insert is coupled to the bearing retainer by way of a shrink fit.

19. The pump of claim 12 further comprising channels on the inside surface of the bearing insert in order to allow for flow of fluid through the sleeve bearing.

20. The pump of claim 19 wherein the channels are semicircular in shape.

21. The pump of claim 12 wherein the bearing insert is heat treated.

22. The pump of claim 12 wherein only a portion of the bearing insert is heat treated.

23. The pump of claim 12 wherein the sleeve bearing is coupled to the column pipe.

24. The pump of claim 12 further comprising a shaft sheath extending from the head portion and located between the column pipe and the line shaft.

25. The pump of claim 22 wherein the sleeve bearing is coupled to the shaft sheath.

26. A method of manufacturing a sleeve bearing for use in a fluid delivery system, said method comprising steps of:
forming a bearing retainer including an outer surface and an inner surface wherein the inner surface forms a retaining bore;
forming a bearing insert including an outside surface and an inside surface wherein the inside surface forms a shaft bore; and
coupling the bearing insert to the bearing retainer.

27. The method of claim 26 further comprising a step of forming the bearing retainer from stainless steel and said bearing insert from a thermoplastic resin.

28. The method of claim 26 further comprising a step of forming the bearing insert from a Vesconite.

29. The method of claim 26 further comprising a step of forming a location feature on the outer surface of the bearing retainer.

30. The method of claim 26 further comprising a step of threading the outer surface.

31. The method of claim 26 further comprising a step of coupling the bearing insert to the bearing retainer by way of a press fit.

32. The method of claim 26 further comprising a step of coupling the bearing insert to the bearing retainer by way of a shrink fit.

33. The method of claim 26 further comprising a step of forming channels on the inside surface of the bearing insert in order to allow for flow of fluid through the sleeve bearing.

34. The method of claim 33 further comprising a step of forming channels in a semicircular shape.

35. The method of claim 26 further comprising a step of heat treating the bearing insert.

36. The method of claim 26 further comprising a step of heat treating only a portion of bearing insert.
